(19) United States
(12) Patent Application Publication
(10) Pub. No.: US 2008/0115209 A1
(43) Pub. Date: May 15, 2008

(54) CREDENTIAL SUBSTRATE PROCESSING AUTHORIZATION

(75) Inventors: David Alan Fontanella, Plymouth, MN (US); Traci L. Johnson, Savage, MN (US); Gary M. Klinefelter, Eden Prairie, MN (US); John E. Ekers, Plymouth, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Fargo Electronics, Inc., Eden Prairie, MN (US)

(21) Appl. No.: 11/936,449

(22) Filed: Nov. 7, 2007

Related U.S. Application Data
(60) Provisional application No. 60/857,893, filed on Nov. 10, 2006.

(51) Int. Cl. G06F 21/00

(52) U.S. Cl. 726/19

(57) ABSTRACT

In a method of authorizing credential substrate processing in a credential manufacturing device, a credential manufacturing device and a credential substrate are provided. The credential substrate includes a memory containing a unique identifier. An authorized credential substrate identification stored in a data store is accessed. The authorized credential substrate identification identifies a specific credential substrate. The authorized credential substrate identification is compared to the unique identifier of the credential substrate. The processing of the credential substrate using the credential manufacturing device is prevented when the authorized credential substrate identification does not match the unique identifier.

The present application claims the benefit of U.S. Provisional Patent Application Ser. No. 60/857,893, filed Nov. 10, 2006, which is incorporated herein by reference in its entirety.

### BACKGROUND OF THE INVENTION

Credentials include identification cards, driver's licenses, passports, and other valuable documents. Credential manufacturing systems used to make such credentials generally include at least one credential processing device that processes a credential substrate to perform at least one step in forming the final credential product. Such credential processing devices include, for example, printing devices for printing images to the credential substrate, laminating devices for laminating an overlaminate to the credential substrate, devices for attaching labels, and data writing or encoding devices for encoding data to the substrate. Credential production devices process a credential substrate in response to a credential processing job generated by a credential producing application. The credential processing job generally defines the printing, laminating, attaching and/or encoding processes that are to be performed by the credential manufacturing device on the credential substrate.

There is a great demand for generating credentials that include security features that are designed to prevent counterfeiting. In one example, printed credentials, such as identification cards, can be laminated with an overlaminate that includes custom security markings, such as holograms, which cannot be easily duplicated. Also, credentials can include special layers of materials that reveal attempts to tamper with the credential. Similar to lamination, security labels can be attached with or without heating

There is also a great demand to prevent the unauthorized use of credential manufacturing systems to produce unauthorized credentials. In one example, the consumable supplies (e.g., print ribbon, overlaminate supply, label supply, substrate supply, etc.) that are required to produce the consumable are customized for limited use with only specifically authorized credential production devices, such as disclosed in U.S. Patent Publication No. 2003/0216826 assigned to Fargo Electronics, Inc. of Eden Prairie, Minn. Such a limitation on the use of the customized supplies can prevent a counterfeiter from seizing the supplies and using them with an unauthorized credential production device to produce counterfeit credentials. However, one who has access to both the customized supplies and the authorized credential manufacturing system could still produce an unauthorized credential.

U.S. Patent Publication No. 2006/0123471 discloses a system and method for providing security from unauthorized credential production using an authorized credential production device. In general, the consumable supplies have an enabled and a disabled state. The authorized credential production device can only use the consumable to form a credential when the consumable is in the enabled state. That is, when the consumable is in the disabled state, credential production using the consumable in an authorized on-site credential production device that is configured to use the consumable, is prohibited.

There exists a continuous demand to provide higher levels of security with regard to the production of credentials.

### SUMMARY

Embodiments of the invention are generally directed to methods and systems for authorizing credential substrate processing in a credential production system. More specifically, embodiments of the methods and system prevent a credential manufacturing device from processing credential substrates that have not been specifically identified as being authorized for processing.

In one embodiment of the method, a credential manufacturing device and a credential substrate are provided. The credential substrate includes a memory containing a unique identifier. An authorized credential substrate identification stored in a data store is accessed. The authorized credential substrate identification identifies a specific credential substrate. The authorized credential substrate identification is compared to the unique identifier of the credential substrate. The processing of the credential substrate using the credential manufacturing device is prevented when the authorized credential substrate identification does not match the unique identifier.

One embodiment of the system comprises a credential manufacturing device, a credential substrate, a data store comprising a computer readable medium and an authorized credential substrate identification stored in the data store. The credential substrate comprises a memory containing a unique identifier. The authorized credential substrate identification identifies a specific credential substrate. The system also comprises one or more computer-readable storage media comprising computer-executable instructions for implementing a method of authorizing credential substrate processing. In the method, the authorized credential substrate identification is accessed and compared to the unique identifier of the credential substrate. Processing of the credential substrate using the credential manufacturing device is prevented when the authorized credential substrate identification does not match the unique identifier.

Other features and benefits that characterize embodiments of the present invention will be apparent upon reading the following detailed description and review of the associated drawings.

### BRIEF DESCRIPTION OF THE DRAWINGS

FIG. 1 is a simplified diagram of a credential manufacturing system in accordance with embodiments of the invention.

FIG. 2 is a schematic diagram of credentials and a credential supply in accordance with embodiments of the invention.

FIG. 3 is a simplified diagram of a print head in accordance with embodiments of the invention.

FIG. 4 is a simplified diagram of a laminator in accordance with embodiments of the invention.

FIG. 5 is a simplified diagram of a data writer in accordance with embodiments of the invention.

FIG. 6 is a flowchart illustrating a method of authorizing credential substrate processing in a credential manufacturing system, in accordance with embodiments of the invention.

### DETAILED DESCRIPTION OF THE PREFERRED EMBODIMENTS

Embodiments of the invention may be described in the general context of applications or programs, which comprise computer-executable instructions stored in tangible computer-readable media. Each memory or data store referenced herein comprises such tangible computer-readable media. Generally, the computer-executable instructions include routines, programs, objects, components, data structures, etc. that perform particular tasks (i.e., method steps) or implement particular abstract data types. Accordingly, computer-executable instructions comprise, for example, instructions and data which cause a general purpose computer, special purpose computer, or special purpose processing device to perform a certain function or group of functions. Method steps of the present invention described below involve the execution of such computer-executable instructions and, unless otherwise specified, do not correspond to the manual performance of the step by an operator.

Embodiments of the computer-readable media that contain the computer-executable instructions or data structures can be any available tangible media that can be accessed by a general purpose or special purpose computer. By way of example, and not limitation, such computer-readable media can comprise physical storage media such as RAM, ROM, EEPROM, CD-ROM or other optical disk storage, magnetic disk storage or other magnetic storage devices, or any other medium that can be used to carry or store desired program code in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, such a connection is also properly termed a computer-readable medium. Combinations of the above should also be included within the scope of computer-readable media.

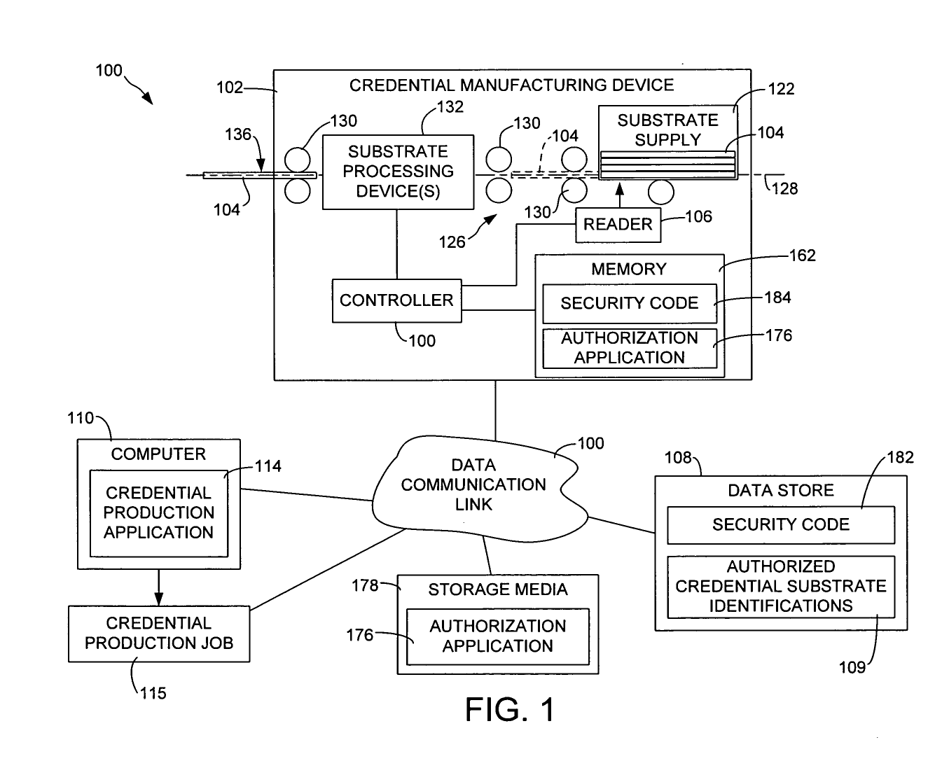

Embodiments of the present invention are directed to systems and methods for authorizing credential substrate processing. FIG. 1 is a simplified diagram of a credential manufacturing system 100 in accordance with embodiments of the invention. Embodiments of the system 100 include a credential manufacturing device 102 configured to process one or more credential substrates 104, a memory reader 106 and a data store 108 (i.e., computer-readable media) containing one or more authorized credential substrate identifications 109.

The various components of the system 100 are illustrated in FIG. 1 as being coupled for data communication through a data communication link 112. The data communication link 112 represents one or more data communication links, such as physical communication links (e.g., cable) and wireless communication links (e.g., radio frequency, infrared, etc.) between the various components of the system 100. The data communication link 112 can represent direct communication links between components of the system 100 as well as network communication links between components of the system 100.

Embodiments of the system 100 also include a computer 110 configured to host or provide user access to a credential production application 114. The credential production application 114 is designed to produce a credential production job 115, possibly after processing by a driver program (not shown) that is configured to form the credential production job 115 in accordance with a format that is compatible with the credential manufacturing device 102 responsible for processing it. The credential production job 115 includes data and instructions relating to one or more credential forming processes to be performed on one or more of the credential substrates 104. The credential manufacturing device 104 is configured to process the credential production job 115 by performing the processes described therein in order to form, or partially form, the desired credential (e.g., identification card, driver's license, credit card, passport, etc.). However, as explained in greater detail below, the credential manufacturing device 102 is prevented from performing the processes of the credential production job 115 on non-authorized credential substrates 104. That is, unless it is determined that a credential substrate 104 is authorized for processing in accordance with the credential production job 115, the credential substrate 104 will not be processed by the credential manufacturing device 102.

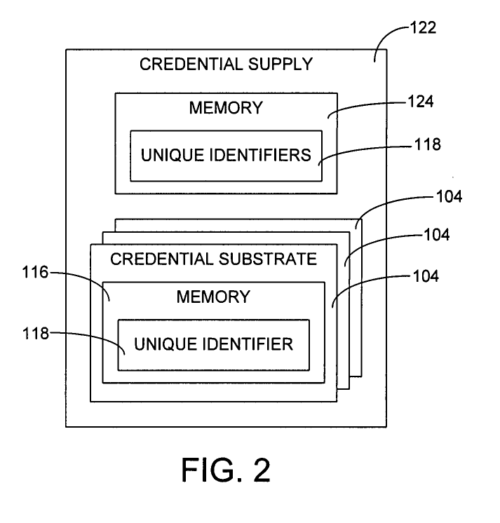

Exemplary embodiments of the credential substrates 104 include card substrates, plastic card substrates, paper substrates, substrates used to form passports, and other credential substrates. In one embodiment, the credential substrates 104 each include a memory 116, as shown schematically in FIG. 2. Embodiments of the memory 116 include programmable and non-programmable (i.e., non-writable or fixed data) tangible recording media including, for example, a radio frequency identification (RFID) tag or chip, a contact memory chip, a magnetic stripe or other form of memory that can store data that can be read or accessed using the memory reader 106.

In one embodiment, the memory 116 of each substrate contains a unique identifier 118, such as a serial number for the substrate. The unique identifier allows each substrate 104 to be distinguished from other substrates 104. Alternatively, the credential substrates 114 can be contained in a cartridge or supply 122 having a memory 124 containing the unique identifiers 118 for each of the substrates that are contained in the supply 122. In one embodiment, the memory 124 of the supply 122 contains a unique identifier for the supply 122. The memory 124 can also maintain a count of the number of credential substrates 104 remaining in the supply 122. The individual substrates contained in the cartridge may still contain the memory and unique identifier.

In one embodiment, the memory 116 includes state information that identifies whether the credential or cartridge of credentials is in an enabled or disabled state, as discussed in U.S. Patent Publication No. 2006/0123471 (U.S. application Ser. No. 11/261,450), which was filed Oct. 28, 2005 and is incorporated herein by reference in its entirety.

The authorized credential substrate identifications 109 generally identify one or more credential substrates 104, based on their unique identifiers 118, that are authorized for processing by the credential manufacturing device 102 of the system 100. Embodiments of the authorized credential substrate identifications 109 include a list of the identifications or a data structure containing the identifications, for example. Each of the authorized credential substrate identifications 109 can also include other information regarding the credential substrate 104 to which the identification 109 corresponds, such as a type of corresponding credential substrate 104, an identification of the supply 122 in which the corresponding credential 104 is contained and other information.

One embodiment of the credential manufacturing device 102 includes the substrate supply 122 that is configured to hold a plurality of the credential substrates 104. Alternatively, individual credential substrates 104 can be fed into the credential manufacturing device 102 by hand. A substrate transport mechanism 126 is configured to feed individual substrates 104 along a processing path 128. The substrate transport mechanism 126 can include, for example, motor-driven rollers including pinch roller assemblies, such as assemblies 130, or other substrate feeding components designed to feed an individual substrate 104 from the supply 122 along the processing path 128. Embodiments of the credential manufacturing device 102 also include sensors, such as a substrate sensor (not shown) that is configured to detect the feeding of a substrate 104 from the supply 122.

In accordance with one embodiment, the credential manufacturing device 102 is in the form of an identification card printer that processes plastic card substrates 104 in accordance with the credential production job 115 to form an identification card. Plastic card substrates 104 used in such identification card printers are rigid or semi-rigid substrates that are susceptible to damage from excessive bending. As a result, one embodiment of the transport mechanism 126 is designed to avoid such bending of the card substrate 104 as it is fed along the processing path 128. In one embodiment, the processing path 128 is substantially flat, as illustrated in FIG. 2. That is, the processing path 128 may contain slight bends that do not damage the plastic card substrates 104, but lacks the significant bends of paper sheet feed mechanisms used in conventional paper sheet printers and copiers. Accordingly, those skilled in the art of credential manufacturing devices used to process the plastic card substrates 104 to form identification cards or credit cards understand that the transport mechanism 126 of the present invention differs substantially from paper sheet feed mechanisms of paper sheet printers and copiers, that transport paper sheets and other highly malleable substrates through a path that includes many bends that are unsuitable for the plastic substrates 104 used by the identification card printer embodiment of the credential manufacturing device 102 of the present invention.

One embodiment of the credential manufacturing device 102 includes at least one substrate processing device 132 configured to process the individual substrates 104. While these processing devices 132 will be discussed with reference to the processing of plastic card substrates used to form identification cards or credit cards, it is understood that that the substrate processing devices 132 described herein can be used to process the other types of credential substrates mentioned above.

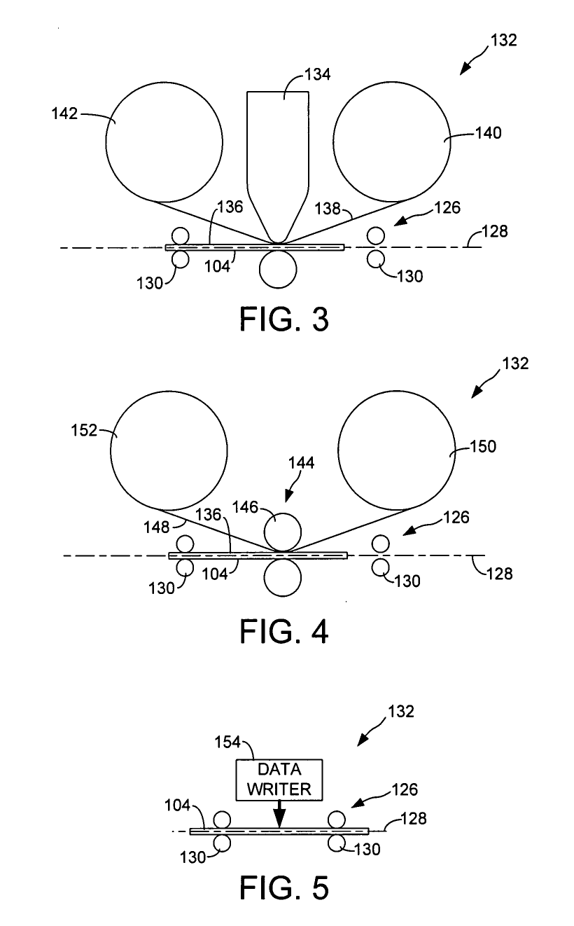

One embodiment of the substrate processing device 132 includes a print head 134, illustrated schematically in FIG. 3, that is configured to print an image to a surface, such as top surface 136, of the plastic card substrate 104 that is delivered along the processing path 128 by the transport mechanism 126. The print head 134 can be any conventional print head used in credential manufacturing devices 104. In accordance with one embodiment, the print head and the processing device includes a thermal print ribbon 138 wound between a supply spool 140 and a take-up spool 142. In one embodiment, the print ribbon 138 comprises panels of different colored dye (e.g., cyan, magenta, yellow, black). In accordance with this embodiment, the print head 134 applies heat and pressure to the print ribbon 138 and surface 136 to cause they dye to sublimate into the surface 136 of the substrate 104. Exemplary print heads of credential manufacturing devices are described in U.S. Pat. Nos. 7,154,519 and 7,018,117 and U.S. application Ser. No. 10/647,666, each of which are incorporated herein by reference in their entirety.

Another embodiment of the substrate processing device 112 includes a laminator 144, such as that illustrated in the simplified diagram of FIG. 4. The laminator 144 comprises a laminating roller 146 that is configured to apply heat and pressure to an overlaminate film 148 and the surface 136 of the substrate 104, such as surface 114, to laminate the overlaminate film 148, or an overlaminate patch, to the surface 136 of the substrate 104 that is in the processing path 128. The overlaminate film 148 can be wound between a supply roll 150 and a take-up roll 152.

Another embodiment of the substrate processing device 132 includes a data writer or encoder 154, shown schematically in FIG. 5. The data writer 154 is configured to read and/or write data to the substrate 104, such as the memory 116, for example. Exemplary data writers or encoders 154 include a magnetic stripe writer that is configured to write data to a magnetic stripe of the card substrate 104, a smart card writer that is configured to write data to memory of a smart card chip of the card substrate 104 either wirelessly or through direct contact, and other data writers of card manufacturing devices.

One embodiment of the credential manufacturing device 102 includes one or more controllers (e.g., microprocessors), represented in FIG. 2 as controller 160. The controller 160 operates to control the operation of the credential manufacturing device 102 including, receiving signals from sensors, controlling the credential processing devices 132, the transport mechanism 126, the memory reader 106 and other components of the credential manufacturing device 102. The controller 160 can also represent the components used for data communications through the data communication link 112. Additionally, the controller 160 is configured to process the credential production jobs 115. Program instructions for processing the credential production jobs are stored in a tangible medium, such as memory 162, and are executable by the controller 160.

Embodiments of the invention are directed to preventing a credential manufacturing device 102 from processing credential substrates 104 that have not been specifically identified as being authorized for processing. This operates to reduce the likelihood of someone producing unauthorized credentials using the system 100 of the present invention even when the credential supply is generally authorized (e.g., authenticated) for use with the credential manufacturing device 102 of the system 100. In general, the credential manufacturing device 102 is either authorized to process a credential substrate 104 or unauthorized to process the substrate 104, based on whether one of the authorized credential substrate identifications 109 match the unique identifier 118 corresponding to the substrate 104 that is to be processed by the credential manufacturing device 102.

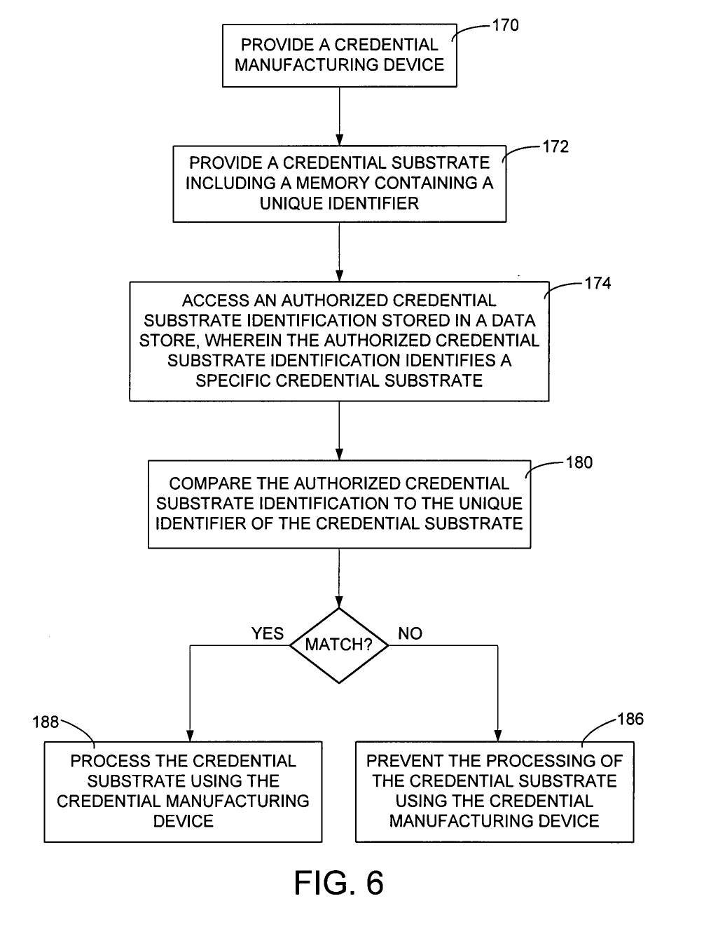

FIG. 6 is a flowchart illustrating a method of authorizing credential substrate processing in the credential manufacturing system 100, in accordance with embodiments of the invention. At steps 170 and 172, a credential manufacturing device 102 and a credential substrate 104 are provided. The credential manufacturing device 102 is in accordance with the embodiments described herein. In one embodiment of step 172, a credential substrate 104 is fed from a supply 102 that is attached to, or a component of the credential manufacturing device 102, using the transport mechanism 126. In another embodiment, the credential substrate 104 hand fed to the transport mechanism 126.

One or more of the authorized credential substrate identifications 109 are accessed, at step 174. In one embodiment, step 174 is performed in response to the credential manufacturing device 102 receiving a credential production job 115 for processing. In one embodiment, step 174 and other steps of the method are performed in response to the execution of computer-executable instructions, represented as authorization application 176 (FIG. 1), stored in a computer-readable storage media, such as memory 162, which is local to the credential manufacturing device 102, and/or a computer-readable storage media 178, which is remote from the credential manufacturing device 102, for example. Thus, it is understood by those skilled in the art that the authorization application 176 may comprise multiple separate applications (i.e., computer-executable instructions) stored in multiple locations. The authorization application 176 may be executed by one or more computing devices, such as the controller 160 of the credential manufacturing device 102, the computer 110, a server (not shown), and/or other computing device capable of communicating with the credential manufacturing device 102 through the data communication link 112.

The unique identifier 118 for the substrate that is positioned to be fed into the credential manufacturing device 102 for processing is accessed from the memory 116 or the memory 124. In one embodiment, the unique identifier 118 is retrieved for the controller 160 using the memory reader 106. In one embodiment, the memory reader 106 accesses the unique identifier 118 of the substrate 104 that is next in line for processing prior to it being fed along the processing path 128 and, thus, prior to being fed from the supply 122. In another embodiment, the unique identifier of the substrate 104 that is next in line for processing is read as it is fed along the processing path 128.

At step 180, the authorized credential substrate identification 109 is compared to the accessed unique identifier 118 corresponding to the substrate 104 that is to be processed by the credential manufacturing device 102. In one embodiment, one or both of the authorized credential substrate identification 109 and the unique identifier 118 are decoded prior to the comparison. In one embodiment, the system 100 includes a security code or key, such as, for example, security code 182 stored in the data store 108 or security code 184 stored in the memory 162, that is used in the decoding of the substrate identification 109 or the unique identifier 118. In another embodiment, an algorithm or rule is performed on the substrate identification 109 or the unique identifier 118 during the decoding process.

If it is determined that the authorized credential substrate identification 109 does not match the unique identifier 118, the credential manufacturing device 102 is prevented from processing the credential substrate 104 and the credential production job 115 is not completed using the subject credential substrate 104, as indicated at 186. In one embodiment, the credential manufacturing device 102 sends a notice to the computer 110 or the operator responsible for generating the credential production job 115, that the credential production job 115 could not be processed.

If it is determined that the authorized credential substrate identification 109 matches the unique identifier 118, the credential manufacturing device 102 is allowed to process the credential substrate 104 in accordance with the credential production job 115, as indicated at step 188. Embodiments of the processing step 188 include the performance of the processes described above using the corresponding substrate processing device 132. Accordingly, exemplary processes performed in step 188 on the substrate 104 include printing an image to a surface of the substrate 104 using the print head 134, laminating an overlaminate film on to a surface of the credential substrate 104 using the laminating roller 146 and/or writing data to the credential substrate 104 using the data writer 154.

In one embodiment, an audit trail is maintained regarding the processing of the credential substrates 104. Exemplary embodiments of the audit trail include an identification of the card substrates (e.g., the unique identifier) and information about the operator that processed the substrate using the credential manufacturing device 102, an identification of the credential manufacturing device 102 that processed the substrate (e.g., serial number), an identification of the one or more consumables (e.g., print ribbon identifier, overlaminate identifier, etc.) used to process the substrate 104, the processing steps performed on the substrate by the credential manufacturing device 102, date and time information for relating to the processing of the substrate 104, and other information. Additionally, defective credential substrates can be identified in the audit trail and are preferably destroyed.

Although the present invention has been described with reference to preferred embodiments, workers skilled in the art will recognize that changes may be made in form and detail without departing from the spirit and scope of the invention.

What is claimed is:

1. A method of authorizing credential substrate processing in a credential manufacturing system comprising:
providing a credential manufacturing device;
providing a credential substrate including a memory containing a unique identifier;
accessing an authorized credential substrate identification stored in a data store, wherein the authorized credential substrate identification identifies a specific credential substrate;
comparing the authorized credential substrate identification to the unique identifier of the credential substrate; and
preventing processing of the credential substrate using the credential manufacturing device when the authorized credential substrate identification does not match the unique identifier.

2. The method of claim 1, wherein:
the credential substrate comprises a plastic card substrate;
the credential manufacturing device comprises a print head; and
printing an image on a surface of the credential substrate using the print head when the unique identifier matches the authorized credential substrate identification.

3. The method of claim 1, wherein:
the credential substrate comprises a plastic card substrate;
the credential manufacturing device comprises a laminating roller; and
laminating an overlaminate film on to a surface of the credential substrate using the laminating roller when the unique identifier matches the authorized credential substrate identification.

4. The method of claim 1, wherein:
the credential substrate comprises a plastic card substrate;
the credential manufacturing device comprises a data writer; and
writing data to the credential substrate using the data writer when the unique identifier matches the authorized credential substrate identification.

5. The method of claim 1, wherein the data store is remote from the credential manufacturing device and the credential substrate.

6. The method of claim 1, wherein accessing an authorized credential substrate identification from a data store is performed by the credential manufacturing device.

7. The method of claim 1, wherein comparing the authorized credential substrate identification to the unique identifier comprises decoding at least one of the authorized credential substrate identification and the unique identifier.

8. The method of claim 1, wherein:
the method comprises receiving a credential production job at the credential manufacturing device; and
preventing processing of the credential substrate comprises preventing processing of the credential production job by the credential manufacturing device.

9. A credential manufacturing system comprising:
a credential manufacturing device;
a credential substrate comprising a memory containing a unique identifier;
a data store comprising a computer readable medium;
an authorized credential substrate identification stored in the data store, wherein the authorized credential substrate identification identifies a specific credential substrate; and
one or more computer-readable storage media comprising computer-executable instructions for implementing a method of authorizing credential substrate processing, wherein the method comprises:
accessing the authorized credential substrate identification;
comparing the authorized credential substrate identification to the unique identifier of the credential substrate; and
preventing processing of the credential substrate using the credential manufacturing device when the authorized credential substrate identification does not match the unique identifier.

10. The system of claim 9, wherein:
the credential substrate comprises a plastic card substrate;
the credential manufacturing device comprises a print head; and
the method comprises printing an image on a surface of the credential substrate using the print head when the unique identifier matches the authorized credential substrate identification.

11. The system of claim 9, wherein:
the credential substrate comprises a plastic card substrate;
the credential manufacturing device comprises a laminating roller; and
the method comprises laminating an overlaminate film on to a surface of the credential substrate using the laminating roller when the unique identifier matches the authorized credential substrate identification.

12. The system of claim 9, wherein:
the credential substrate comprises a plastic card substrate;
the credential manufacturing device comprises a data writer; and
the method comprises writing data to the credential substrate using the data writer when the unique identifier matches the authorized credential substrate identification.

13. The system of claim 9, wherein the data store is remote from the credential manufacturing device and the credential substrate.

14. The system of claim 9, wherein comparing the authorized credential substrate identification to the unique identifier comprises decoding at least one of the authorized credential substrate identification and the unique identifier.

15. A credential manufacturing system comprising:
an identification card printer;
a plastic card substrate comprising a memory containing a unique identifier;
a data store comprising a computer readable medium;
an authorized credential substrate identification stored in the data store, wherein the authorized credential substrate identification identifies a specific credential substrate; and
one or more computer-readable storage media comprising computer-executable instructions for implementing a method of authorizing credential substrate processing, wherein the method comprises:
accessing the authorized credential substrate identification;
comparing the authorized credential substrate identification to the unique identifier; and
preventing processing of the plastic card substrate using the identification card printer when the authorized credential substrate identification does not match the unique identifier.

16. The system of claim 15, wherein:
the identification card printer comprises a print head; and
the method comprises printing an image on a surface of the credential substrate using the printing device when the unique identifier matches the authorized credential substrate identification.

17. The system of claim 15, wherein:
the identification card printer comprises credential laminating device comprising a laminating roller; and
the method comprises laminating an overlaminate film on to a surface of the credential substrate using the laminating device when the unique identifier matches the authorized credential substrate identification.

18. The system of claim 15, wherein:
the identification card printer comprises a data writer; and
the method comprises writing data to the credential substrate using the data writer when the unique identifier matches the authorized credential substrate identification.

19. The system of claim 15, wherein the data store is remote from the identification card printer and the plastic credential substrate.

20. The system of claim 15, wherein comparing the authorized credential substrate identification to the unique identifier comprises decoding at least one of the authorized credential substrate identification and the unique identifier.
